(19) United States
(12) Patent Application Publication
(10) Pub. No.: US 2026/0029230 A1
(43) Pub. Date: Jan. 29, 2026

(54) MEASUREMENT SYSTEM

(71) Applicant: SANKYO SEISAKUSHO CO., Tokyo (JP)

(72) Inventors: Naoyuki TAKAHASHI, Kikugawa (JP); Kazuteru TOBITA, Fukuroi (JP)

(73) Assignee: SANKYO SEISAKUSHO CO., Tokyo (JP)

(21) Appl. No.: 18/998,018

(22) PCT Filed: Jul. 3, 2023
(86) PCT No.: PCT/JP2023/024584

§ 371 Date: Jan. 23, 2025

(30) Foreign Application Priority Data
Jul. 29, 2022 (JP) 2022-121385

(51) Int. Cl. G01B 11/26

(52) U.S. Cl. CPC G01B 11/26

(57) ABSTRACT

Provided is a system for measuring the state of a rotary member which can rotate around a rotary member axis line. The system comprises a measurement device including: a rotary mechanism; a support member which can rotate around a support member axis line by means of the rotary member; and a displacement meter that is disposed on the support member. The system further comprise an inclined reference surface, wherein the displacement meter is configured to measure the distance to the inclined reference surface, the rotary member is fixed at a designated measurement position, the rotary mechanism rotates the support member at the measurement position of the rotary member, and the displacement meter measures the distances to the inclined reference surface at a plurality of scan angles due to the rotation of the support member and measures the state of the rotary member on the basis of the distances at the plurality of scan angles.

### TECHNICAL FIELD

The present invention relates to a measurement system capable of directly, highly accurately, and easily measuring the state of a rotary member.

### BACKGROUND ART

A workpiece is disposed at any position on the surface of a rotary member and fabricated and/or examined while the rotary member is rotated. In a case where it is needed to highly accurately position the workpiece for fabrication and/or examination, it is needed to directly and highly accurately measure a rotational movement angle with the position on the surface of the rotary member as a measurement position. For example, in a case where a gyro sensor is disposed at the measurement position, the rotational movement angle can be directly measured. Alternatively, the rotational movement angle can be measured by a rotary encoder. Furthermore, it is needed to highly accurately measure the perpendicularity or parallelism of the surface of the rotary member relative to a rotary member axis line and the perpendicularity or parallelism of the rotary member axis line relative to a reference surface. When the workpiece disposed on the surface of the rotary member is fabricated while the perpendicularity or the parallelism is not adjusted, fabrication error occurs to the workpiece. The perpendicularity and the parallelism are measured, for example, by scanning a displacement meter on the surface of the rotary member by using a precision surface plate, a three-dimensional measuring device, or the like, and calculating the scanning result.

Patent Literature 1 discloses a movement environment recognition method of projecting, to a measurement target, conical scanning detection light that scans in directions along a conical surface centered on a sighting direction from a sensor origin, receiving the conical scanning detection light reflected by the intersection circle between the conical scanning detection light and the surface of the measurement target to measure the distance from the sensor origin to the measurement target, calculating characteristic amounts of the intersection circle based on the measured distance, and determining the shape of the surface of the measurement target based on the characteristic amounts of the intersection circle.

### CITATION LIST

### Patent Literature

PATENT LITERATURE 1: JP-A-2011-059071

### SUMMARY OF INVENTION

### Technical Problem

The detection resolution of a gyro sensor, even for high-precision models, is on the order of 1/10°, and gyro sensors have the problem that they cannot measure the rotational movement angle with high precision, for example, on the order of 1/3600°. On the other hand, the scale plate of a rotary encoder needs to be disposed coaxially with the rotary member axis line and cannot directly measure the rotational movement angle as the measurement position. Furthermore, deformation occurs to members from the rotary member axis line to the measurement position, and thus rotary encoders have the problem that the rotational movement angle on the rotary member axis line does not match the actual rotational movement angle at the measurement position. This is particularly significant when the rotary member axis line is horizontal and a gravitational load is applied in the rotational direction at the measurement position. In addition, large-scale facility is typically needed for measurement of the perpendicularity and the parallelism, which poses the problem that a measurement environment cannot be established in a small space.

With the movement environment recognition method of Patent Literature 1, the measurement result of the distance from the sensor origin to the measurement target varies depending on the posture of the measurement target, and the characteristic amounts of the intersection circle obtained from the measurement result vary as well, which poses the problem that the determined shape of the surface of the measurement target varies.

Thus, the present invention is intended to solve the above-described problems and provide a measurement system capable of directly, highly accurately, and easily measuring the state of a rotary member.

### Solution to Problem

According to one aspect of the present invention, a system for measuring a state of a rotary member that can rotate around a rotary member axis line includes a measurement device including: a rotary mechanism: a support member that can rotate around a support member axis line by means of the rotary mechanism; and a displacement meter disposed on the support member. The system further includes an inclined reference surface. The displacement meter is configured to measure a distance to the inclined reference surface. The rotary member is fixed at a designated measurement position. The rotary mechanism rotates the support member at the measurement position of the rotary member. The displacement meter measures the distance to the inclined reference surface at a plurality of scanning angles due to the rotation of the support member and measures the state of the rotary member based on the distance at the plurality of scanning angles.

According to one specific example of the present invention, in the system, the rotary member is fixed at a plurality of designated measurement positions, the rotary mechanism rotates the support member at each designated measurement position of the rotary member, and the displacement meter measures the distance to the inclined reference surface at a plurality of scanning angles due to the rotation of the support member.

According to one specific example of the present invention, in the system, the displacement meter measures a distance waveform of the distance to the inclined reference surface with respect to each scanning angle at each designated measurement position and measures a rotational movement angle at each designated measurement position of the rotary member based on a phase difference between the distance waveforms at the plurality of designated measurement positions.

According to one specific example of the present invention, in the system, the rotary mechanism starts rotation of the displacement meter through the support member from the same position relative to the rotary member at each designated measurement position.

According to one specific example of the present invention, in the system, the support member axis line is parallel to the rotary member axis line.

According to one specific example of the present invention, in the system, the displacement meter measures the distance to the inclined reference surface in a direction parallel to the support member axis line.

According to one specific example of the present invention, in the system, the displacement meter measures the distance to the inclined reference surface in a direction tilted relative to the support member axis line.

According to one specific example of the present invention, in the system, the measurement device is disposed on a surface of the rotary member, the inclined reference surface is inclined at a specific angle relative to a plane perpendicular to the rotary member axis line and disposed to face the measurement device, or the inclined reference surface is inclined at a specific angle relative to a plane perpendicular to the rotary member axis line and disposed on the surface of the rotary member and the measurement device is disposed in the plane perpendicular to the rotary member axis line to face the inclined reference surface.

According to one specific example of the present invention, in the system, in a case where the rotary member rotates so that the surface of the rotary member is substantially perpendicular to the rotary member axis line, perpendicularity of a part of the surface of the rotary member where the measurement device or the inclined reference surface is disposed, relative to the rotary member axis line is measured based on the distance to the inclined reference surface.

According to one specific example of the present invention, in the system, in a case where the rotary member rotates so that the surface of the rotary member is substantially parallel to the rotary member axis line, parallelism of a part of the surface of the rotary member where the measurement device or the inclined reference surface is disposed, relative to the rotary member axis line is measured based on the distance to the inclined reference surface.

### Advantageous Effects of Invention

According to the present invention, a measurement system can directly, highly accurately, and easily measure the state of a rotary member.

Other objects, features and advantages of the present invention will become apparent from the following description of the embodiments of the present invention taken in conjunction with the accompanying drawings.

### BRIEF DESCRIPTION OF DRAWINGS

FIG. 1 is a front view of a system for measuring the state of a rotary member that can rotate around a rotary member axis line, as an embodiment of the present invention.

FIG. 2A is a perspective view of the rotary member and a rotary device in the system of the embodiment in FIG. 1.

FIG. 2B is a perspective view of the rotary member, the rotary device, and a measurement device in the system of the embodiment in FIG. 1.

FIG. 2C is a perspective view of the measurement device in the system of the embodiment in FIG. 1.

FIG. 3A illustrates a front view and a top view of the system of the embodiment in FIG. 1 when the rotational movement angle of the rotary member is 0° and a displacement meter is positioned at a scanning start point.

FIG. 3B illustrates a front view and a top view of the system of the embodiment in FIG. 1 when the rotational movement angle of the rotary member is 180° and the displacement meter is positioned at the scanning start point.

FIG. 4A is a graph of a calculated value of a measurement distance with respect to a scanning angle when the rotational movement angle of the rotary member is 0° and 180° in the system of the embodiment in FIG. 1.

FIG. 4B is a graph of a measured value of the measurement distance with respect to the scanning angle when the rotational movement angle of the rotary member is 0° in the system of the embodiment in FIG. 1.

FIG. 5A is a graph of a scanning radius with respect to a tilt angle when a target measurement resolution of the rotational movement angle of the rotary member is satisfied in the system of the embodiment in FIG. 1.

FIG. 5B is a graph of the bilateral amplitude of a distance waveform with respect to the tilt angle in the system of the embodiment in FIG. 1.

FIG. 6A is a perspective view of the system of the embodiment in FIG. 1 with such change in the disposition place of the measurement device relative to the rotary member that a support member axis line aligns with a rotary member axis line.

FIG. 6B is a perspective view of the system of the embodiment in FIG. 1 with such change that an inclined reference surface is disposed on the rotary member.

FIG. 7A is a front view of a system for measuring the state of the rotary member that can rotate around the rotary member axis line, as another embodiment of the present invention.

FIG. 7B is a perspective view of the system of the embodiment in FIG. 7A.

FIG. 8A is a perspective view of the rotary member and the rotary device in the system of the embodiment in FIG. 7A.

FIG. 8B is a perspective view of the rotary member, the rotary device, and the measurement device in the system of the embodiment in FIG. 7A.

FIG. 9A is a side view of the system of the embodiment in FIG. 7A when the rotational movement angle of the rotary member is 0° and the displacement meter is positioned at the scanning start point.

FIG. 9B is a side view of the system of the embodiment in FIG. 7A when the rotational movement angle of the rotary member is 90° and the displacement meter is positioned at the scanning start point.

FIG. 9C is a side view of the system of the embodiment in FIG. 7A when the rotational movement angle of the rotary member is 180° and the displacement meter is positioned at the scanning start point.

FIG. 10A is a graph of the measured value of the measurement distance with respect to the scanning angle when the rotational movement angle of the rotary member is 0° in the system of the embodiment in FIG. 7A.

FIG. 10B is a graph of the measured value of the measurement distance with respect to the scanning angle when the rotational movement angle of the rotary member is 90° in the system of the embodiment in FIG. 7A.

FIG. 10C is a graph of the measured value of the measurement distance with respect to the scanning angle when the rotational movement angle of the rotary member is 180° in the system of the embodiment in FIG. 7A.

FIG. 11 is a perspective view of the system of the embodiment in FIG. 7A with such change that the inclined reference surface is disposed on the rotary member.

FIG. 12 is a front view of a system for measuring the state of the rotary member that can rotate around the rotary member axis line, as another embodiment of the present invention.

FIG. 13 is a perspective view of the measurement device in the system of the embodiment in FIG. 12.

FIG. 14 is a graph of the calculated value of the measurement distance with respect to the scanning angle when the rotational movement angle of the rotary member is 0° and 180° in the system of the embodiment in FIG. 12.

FIG. 15A is a front view of the system of the embodiment in FIG. 1 when the rotational movement angle of the rotary member is ( ) and the scanning angle of the displacement meter is fixed.

FIG. 15B is a front view of the system of the embodiment in FIG. 1 when the rotational movement angle of the rotary member is 90° and the scanning angle of the displacement meter is fixed.

FIG. 15C is a front view of the system of the embodiment in FIG. 1 when the rotational movement angle of the rotary member is 180° and the scanning angle of the displacement meter is fixed.

FIG. 16 is a front view of the system of the embodiment in FIG. 1 when the rotational movement angle of the rotary member is fixed and the displacement meter is rotated to measure the perpendicularity of the surface of the rotary member.

FIG. 17 is a front view of the system of the embodiment in FIG. 7A when the rotational movement angle of the rotary member is fixed and the displacement meter is rotated to measure the parallelism of the surface of the rotary member.

FIG. 18A illustrates a front view and a top view of a system for measuring the state of the rotary member that can rotate around the rotary member axis line, as another embodiment of the present invention.

FIG. 18B illustrates a front view and a top view of the system of the embodiment in FIG. 18A when the rotational movement angle of the rotary member is 180°.

FIG. 18C illustrates a front view and a top view of the system of the embodiment in FIG. 18A when the rotational movement angle of the rotary member is 180° and the inclined reference surface is disposed such that the tilt angle is the same as in FIG. 18A.

FIG. 19A is a graph of the measured value of the measurement distance with respect to the scanning angle when the rotational movement angle of the rotary member is ( ) in the system of the embodiment in FIG. 18A.

FIG. 19B is a graph of the measured value of the measurement distance with respect to the scanning angle when the rotational movement angle of the rotary member is 180° in the system of the embodiment in FIG. 18A.

FIG. 19C is a graph of the measured value of the measurement distance with respect to the scanning angle when the rotational movement angle of the rotary member is 180° and the inclined reference surface is disposed such that the tilt angle is the same as in FIG. 18A in the system of the embodiment in FIG. 18A.

### DESCRIPTION OF EMBODIMENTS

Embodiments according to the present invention will be described with reference to the drawings. However, the present invention is not limited to those embodiments.

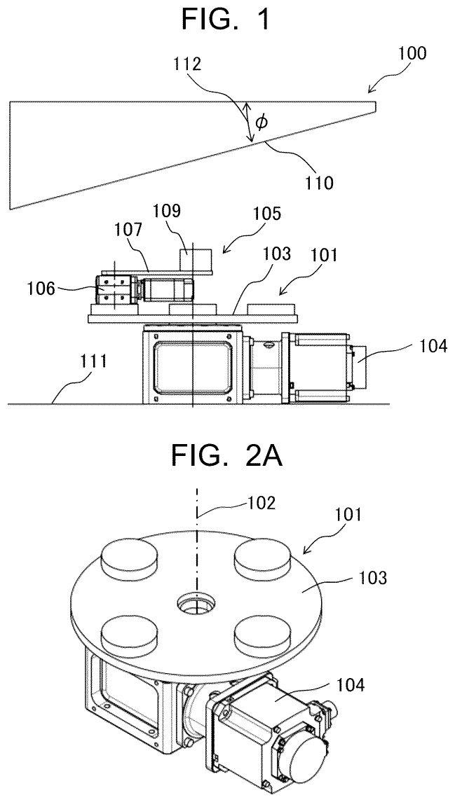

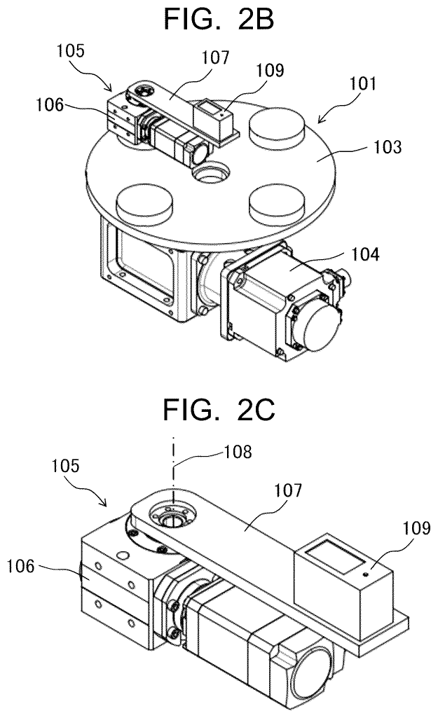

A system 100 for measuring the state of a rotary member 101 that can rotate around a rotary member axis line 102 will be described below as an embodiment of the present invention with reference to FIGS. 1 to 5B. The system 100 includes a measurement device 105 including: a rotary mechanism 106: a support member 107 that can rotate around a support member axis line 108 by means of the rotary mechanism 106; and a displacement meter 109 disposed on the support member 107. The rotary member 101 may rotate by means of a rotary device 104. The rotary device 104 may include a motor, a decelerator, a cam mechanism, or the like to rotate the rotary member 101 but is not limited thereto and only needs to be able to rotate the rotary member 101. The rotary device 104 may include a control unit for controlling rotation of the rotary member 101, and the control unit of the rotary device 104 may be positioned outside the rotary device 104. The rotary mechanism 106 may include a motor, a decelerator, a cam mechanism, or the like to rotate the support member 107, but is not limited thereto and only needs to be able to rotate the support member 107. The rotary mechanism 106 may include a control unit for controlling rotation of the support member 107 and controlling measurement of the displacement meter 109, and the control unit of the rotary mechanism 106 may be positioned outside the rotary mechanism 106.

The system 100 further includes an inclined reference surface 110. The inclined reference surface 110 is disposed such that a tilt angle 112 relative to a plane perpendicular to the rotary member axis line 102 is an angle φ. The displacement meter 109 is configured to measure the distance to the inclined reference surface 110. The displacement meter 109 may include a laser distance meter to measure the distance to the inclined reference surface 110 but is not limited thereto, and may include, for example, a test indicator and only needs to be able to measure the distance to the inclined reference surface 110. The inclined reference surface 110 only needs to be a flat surface and its material is not particularly limited but is preferably compatible with the displacement meter 109 when measuring the distance to the inclined reference surface 110.

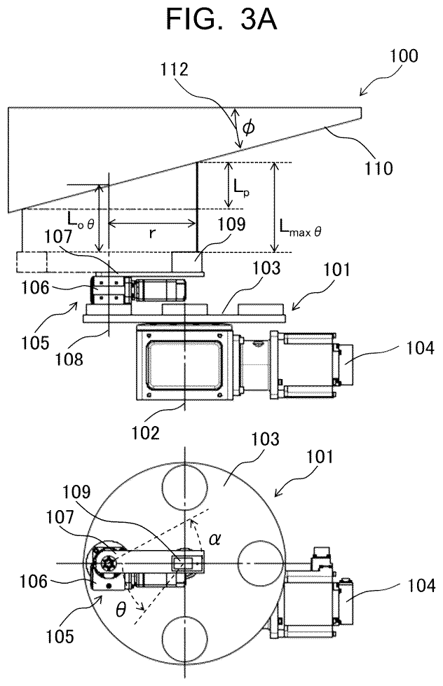

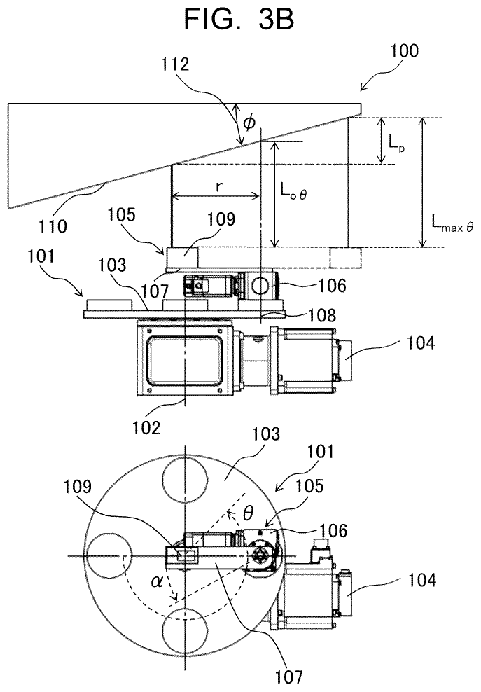

The rotary member 101 is fixed at a designated measurement position, the rotary mechanism 106 rotates the support member 107 at the measurement position of the rotary member 101, and the displacement meter 109 measures the distance to the inclined reference surface 110 at a plurality of scanning angles due to the rotation of the support member 107. FIG. 3A illustrates a case where the designated measurement position of the rotary member 101 is a rotational movement angle θ=0° and the displacement meter 109 is positioned at a scanning start point (α=0°) as a position to start rotation of the displacement meter 109. The rotary member 101 is fixed at the rotational movement angle θ=0° as the designated measurement position, the rotary mechanism 106 rotates the support member 107 at the rotational movement angle θ=0° as the designated measurement position of the rotary member 101, and the displacement meter 109 measures the distance to the inclined reference surface 110 at the scanning angle α that is any rotation angle due to the rotation of the support member 107 from the scanning start point (α=0°). FIG. 3B illustrates a case where the designated measurement position of the rotary member 101 is the rotational movement angle θ=180° and the displacement meter 109 is positioned at the scanning start point (α=0°) as the position to start rotation of the displacement meter 109. The rotary member 101 is fixed at the rotational movement angle θ=180° as the designated measurement position, the rotary mechanism 106 rotates the support member 107 at the rotational movement angle θ=180° as the designated measurement position of the rotary member 101, and the displacement meter 109 measures the distance to the inclined reference surface 110 at the scanning angle α that is any rotation angle due to the rotation of the support member 107 from the scanning start point (α=0°).

When the scanning angle α of the displacement meter 109 is 0° to 360°, a measurement distance L from the displacement meter 109 to the inclined reference surface 110 is obtained as a distance waveform of the following expression.

$$L = {L}_{max θ} - r ( 1 - cos ( α + θ ) ) tan ( φ ) = {L}_{o θ} + r cos ( α + θ ) tan ( φ ) \qquad [ MATH . 1 ]$$

$${L}_{o θ} = {L}_{max θ} - r tan ( φ )$$

In the expression, L_{maxθ} represents the maximum detectable distance from the displacement meter 109 to the inclined reference surface 110 when the rotational movement angle θ is at the designated measurement position of the rotary member 101, r represents the scanning radius of the displacement meter 109 and is, for example, the distance from the support member axis line 108 to a laser beam radiation part of the displacement meter 109 in a case where the displacement meter 109 is a laser distance meter. In addition, L_{oθ} represents a reference distance, and the measurement distance L from the displacement meter 109 to the inclined reference surface 110 has the same amplitude on the positive and negative sides of the reference distance L_{oθ}. A bilateral amplitude Lₚ is obtained by the following expression.

$${L}_{p} = 2 r tan ( φ ) \qquad [ MATH . 2 ]$$

From the above-described expression, the bilateral amplitude Lₚ is not related to the maximum detectable distance L_{maxθ} and the reference distance L_{oθ}. Thus, the distance waveform of the measurement distance L with the same bilateral amplitude Lₚ is obtained as long as the scanning radius r and the angle φ of the tilt angle 112 do not change even when the maximum detectable distance L_{maxθ} and the reference distance L_{oθ} change due to replacement of the displacement meter 109, installation environment change, or the like, and accordingly, excellent redundancy is obtained.

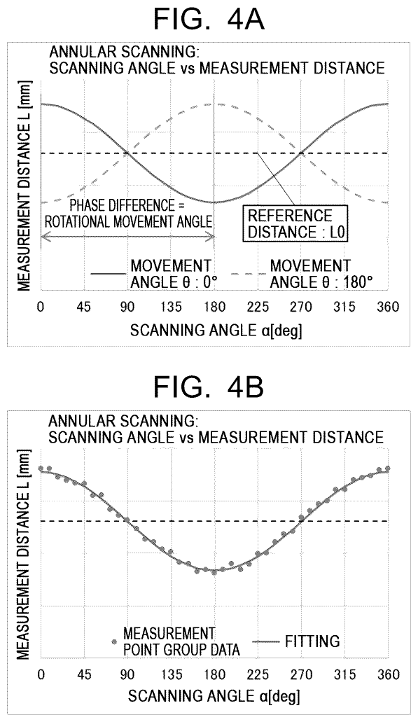

As illustrated in FIG. 4A, the distance waveform of the measurement distance L with respect to the scanning angle α when the rotational movement angle θ as the designated measurement position of the rotary member 101 is 0° and 180° is obtained from [MATH. 1]. Note that, in FIG. 4A, the distance waveform is adjusted so that the reference distance L_{oθ} does not depend on the rotational movement angle θ but is equal to Lₒ. For example, in [MATH. 1], the distance waveform is adjusted so that the reference distance L_{oθ} when α+θ=90° does not depend on the rotational movement angle θ but is equal. Since the bilateral amplitude Lₚ is not related to the maximum detectable distance L_{maxθ} and the reference distance L_{oθ}, adjustment of the reference distance L_{oθ} may be numerically processed. As illustrated in FIG. 4B, the distance waveform of the measurement distance L with respect to the scanning angle α when the rotational movement angle θ as the designated measurement position of the rotary member 101 is 0° is obtained by the displacement meter 109. Since the phase of the distance waveform of the measurement distance L changes in accordance with the rotational movement angle θ as the measurement position of the rotary member 101, the displacement meter 109 measures the distance waveform of the measurement distance L from the displacement meter 109 to the inclined reference surface 110 at each scanning angle α at the rotational movement angle θ as each designated measurement position, and the rotational movement angle θ as each designated measurement position of the rotary member 101 can be obtained based on the phase difference between the distance waveforms of the measurement distance L at the rotational movement angles θ as the plurality of designated measurement positions. For example, in a case where the reference distance L_{oθ} is adjusted so that it does not depend on the rotational movement angle θ but is equal to Lₒ as described above and Lₒ is numerically set to zero. L(θ=0)=r cos α tan φ is obtained for each scanning angle α as the distance waveform of the measurement distance L by the displacement meter 109 when the rotary member 101 is fixed with the rotational movement angle θ=0 as one designated measurement position, and L(θ=θ₀)=r cos(α+θ₀)tan φ is obtained for each scanning angle α as the distance waveform of the measurement distance L by the displacement meter 109 when the rotary member 101 is fixed with the rotational movement angle θ=θ₀ as another designated measurement position. When the measurement position rotationally moves by the rotational movement angle θ₀ as the rotary member 101 rotates, the displacement meter 109 of the measurement device 105 disposed on the rotary member 101 rotationally moves by the rotational movement angle θ₀ and also the phase of the distance waveform of the measurement distance L changes by θ₀, and thus the displacement meter 109 measures the distance waveform of the measurement distance L at each scanning angle α at each of the rotational movement angle θ=0 and θ₀ as two designated measurement positions, and the rotational movement angle θ₀ as each designated measurement position of the rotary member 101 can be obtained based on the phase difference between the distance waveforms of the measurement distance L at the rotational movement angle θ=0 and θ₀ as two designated measurement positions. In other words, the rotational movement angle θ when the rotary member 101 is rotationally moved can be obtained by obtaining the phase difference θ₀ between the two distance waveforms of the measurement distance L. In this manner, the rotational movement angle θ as a measurement position that is the state of the rotary member 101 can be measured based on the measurement distance L at the plurality of scanning angles α. Note that a control unit of the measurement device 105 may obtain the rotational movement angle θ based on the measurement distance L obtained by the displacement meter 109, but the present invention is not limited thereto and the rotational movement angle θ may be obtained by, for example, a processing device positioned outside the rotary mechanism 106.

The rotational movement angle θ as the measurement position of the rotary member 101 may be obtained from the distance waveform of the measurement distance L based on point group data of measured values as illustrated in FIG. 4B, but may be obtained from the distance waveform of the measurement distance L obtained by curve-fitting the point group data of measured values as illustrated in FIG. 4B.

Note that the scanning start point as a position where the rotary mechanism 106 starts rotation of the displacement meter 109 through the support member 107 relative to the rotary member 101 may be any position relative to the rotary member 101, but the rotary mechanism 106 needs to start rotation of the displacement meter 109 through the support member 107 from the scanning start point as the same position relative to the rotary member 101 at the rotational movement angle θ as each designated measurement position. For example, in FIG. 3A, the designated measurement position of the rotary member 101 is the rotational movement angle θ=0° and the displacement meter 109 is positioned at the scanning start point (α=0°) as the position to start rotation of the displacement meter 109, but in FIG. 3B, the designated measurement position of the rotary member 101 is the rotational movement angle θ=180° and the displacement meter 109 is positioned at the scanning start point (α=0°) as the position to start rotation of the displacement meter 109. In this manner, the rotary mechanism 106 needs to start rotation of the displacement meter 109 through the support member 107 from the scanning start point (α=0°) as the same position relative to the rotary member 101 at the rotational movement angle θ as all designated measurement positions including the rotational movement angle θ=0° and 180° as two designated measurement positions, but the scanning start point a is not limited to 0° and may be any angle. Moreover, the rotational direction of the displacement meter 109 may be any direction, but the rotary mechanism 106 needs to start rotation of the displacement meter 109 in the same direction through the support member 107 at the rotational movement angle θ as each designated measurement position.

From [MATH. 1], a detection sensitivity ΔL is maximum when α+θ=90° (or 270°), and is obtained by the following expression.

$$Δ L = \vert L ( 90 ° + Δθ ) - L ( 90 ° ) \vert \qquad [ MATH . 3 ]$$

$$Δ L = \vert {L}_{max} - r ( 1 - cos ( 90 ° + Δθ ) ) tan ( φ ) - ( {L}_{max} - r tan ( φ ) ) \vert$$

$$Δ L = \vert r cos ( 90 ° + Δθ ) tan ( φ ) \vert = \vert r sin ( Δθ ) tan ( φ ) \vert$$

In the expression, Δθ represents a target measurement resolution of rotational mobility θ and is obtained by the following expression.

$$Δθ = {sin}^{- 1} \frac{Δ L}{\vert r tan ( φ ) \vert} \qquad [ MATH . 4 ]$$

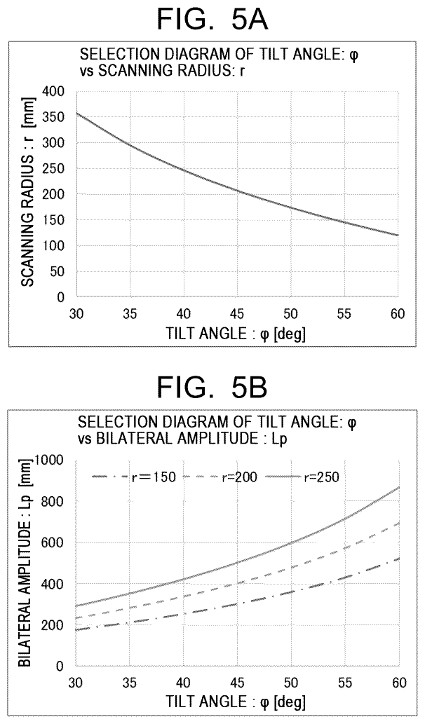

The scanning radius r, the angle φ of the tilt angle 112, and the detection sensitivity ΔL that is the resolution of the displacement meter 109 may be selected to satisfy the target measurement resolution Δθ of the rotational movement angle θ. For example, in a case where the displacement meter 109 with the detection sensitivity ΔL=0.001 mm is used for the measurement resolution Δθ of the rotational mobility θ= 1/3600°, the scanning radius r with respect to the angle φ of the tilt angle 112 when the target measurement resolution Δθ of the rotational movement angle θ of the rotary member 101 is satisfied is obtained as illustrated in FIG. 5A. For example, when the angle φ of the tilt angle 112 is 45°, the scanning radius r with which the target measurement resolution Δθ of the rotational movement angle θ is satisfied is equal to or larger than 200 mm. In addition, from [MATH. 2], the bilateral amplitude Lₚ with respect to the angle φ of the tilt angle 112 when the target measurement resolution Δθ of the rotational movement angle θ of the rotary member 101 is satisfied is obtained as illustrated in FIG. 5B. For example, when the angle φ of the tilt angle 112 is 45°, the bilateral amplitude Lₚ with which the target measurement resolution Δθ of the rotational movement angle θ is satisfied is equal to or larger than 400 mm. The relation between the angle φ of the tilt angle 112 and the scanning radius r indicates values with which instrument selection and designing are possible in reality, which means that the present invention can highly accurately detect the rotational movement angle θ on the order of Δθ= 1/3600°. Moreover, since the two distance waveforms of the measurement distance L with a phase difference are relatively compared instead of processing each distance waveform of the measurement distance L, the dimensional accuracy of the angle φ of the tilt angle 112 and the scanning radius r is not particularly limited. Note that, from [MATH. 4], the displacement meter 109 with the target detection sensitivity ΔL may be selected based on the angle φ of the tilt angle 112 and the scanning radius r.

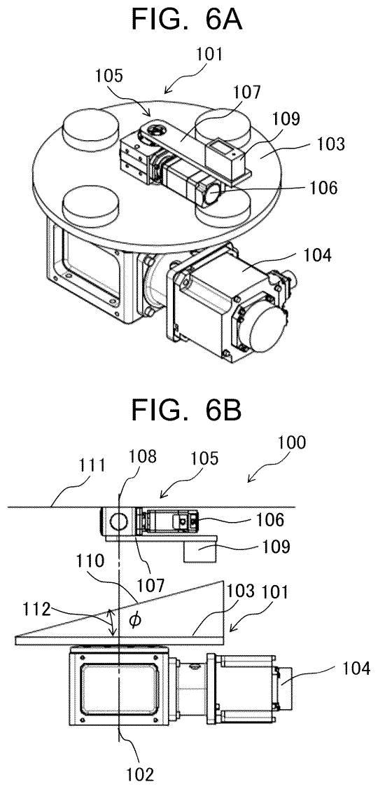

In the system 100 in FIGS. 1 to 3B, the measurement device 105 is disposed on the rotary member 101 such that the support member axis line 108 does not align with a rotary member axis line 102, in other words, is offset from the rotary member axis line 102. However, as illustrated in FIG. 6A, the measurement device 105 may be disposed on the rotary member 101 such that the support member axis line 108 aligns with the rotary member axis line 102, and as long as the support member axis line 108 is parallel to the rotary member axis line 102 even when the disposition place of the measurement device 105 relative to the rotary member 101 is changed, as in the system 100 in FIGS. 1 to 3B, the displacement meter 109 measures the distance waveform of the measurement distance L from the displacement meter 109 to the inclined reference surface 110 at each scanning angle α at the rotational movement angle θ as each designated measurement position, and the rotational movement angle θ as each designated measurement position of the rotary member 101 can be obtained based on the phase difference between the distance waveforms of the measurement distance L at the rotational movement angles θ as the plurality of designated measurement positions.

In the system 100 in FIGS. 1 to 3B, the measurement device 105 is disposed on a surface 103 of the rotary member 101, and the inclined reference surface 110 is inclined at the angle φ of the tilt angle 112 relative to the plane perpendicular to the rotary member axis line 102 and disposed to face the measurement device 105. On the other hand, as illustrated in FIG. 6B, the inclined reference surface 110 may be inclined at the angle φ of the tilt angle 112 relative to the plane perpendicular to the rotary member axis line 102 and disposed on the surface 103 of 15 the rotary member 101, and the measurement device 105 may be disposed in the plane perpendicular to the rotary member axis line 102 to face the inclined reference surface 110, and as long as the support member axis line 108 is parallel to the rotary member axis line 102 even when the disposition places of the measurement device 105 and the inclined reference surface 110 are changed, as in the system 100 in FIGS. 1 to 3B, the displacement meter 109 measures the distance waveform of the measurement distance L from the displacement meter 109 to the inclined reference surface 110 at each scanning angle α at the rotational movement angle θ as each designated measurement position, and the rotational movement angle θ as each designated measurement position of the rotary member 101 can be obtained based on the phase difference between the distance waveforms of the measurement distance L at the rotational movement angles θ as the plurality of designated measurement positions.

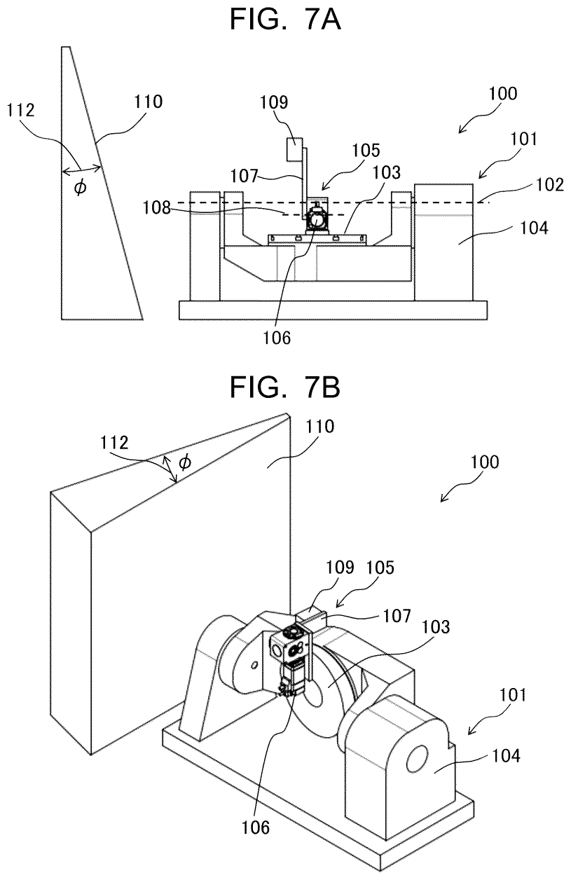

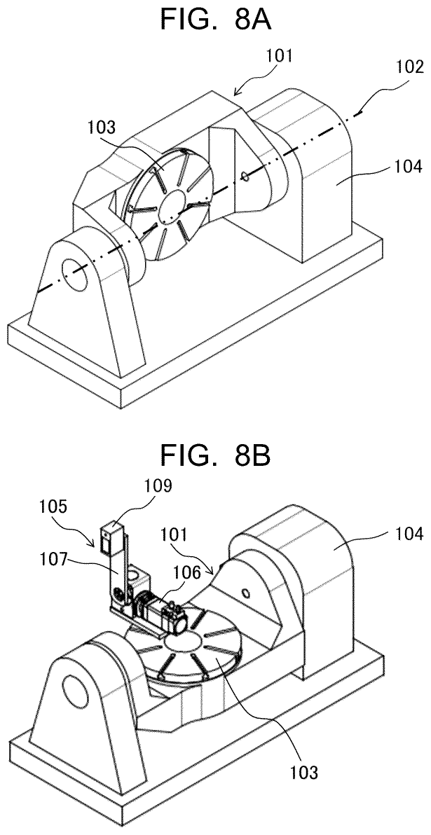

The system 100 for measuring the state of the rotary member 101 that can rotate around the rotary member axis line 102, as another embodiment according to the present invention will be described below with reference to FIGS. 7A to 10C. In the system 100 in FIGS. 1 to 3B, the rotary member 101 is provided such that the surface 103 of the rotary member 101 is substantially perpendicular to the rotary member axis line 102, but in the system 100 in FIGS. 7A to 9C, the rotary member 101 is provided such that the surface 103 of the rotary member 101 is substantially parallel to the rotary member axis line 102. At other points, the configuration of the system 100 in FIGS. 7A to 9C is the same as the configuration of the system 100 in FIGS. 1 to 3B.

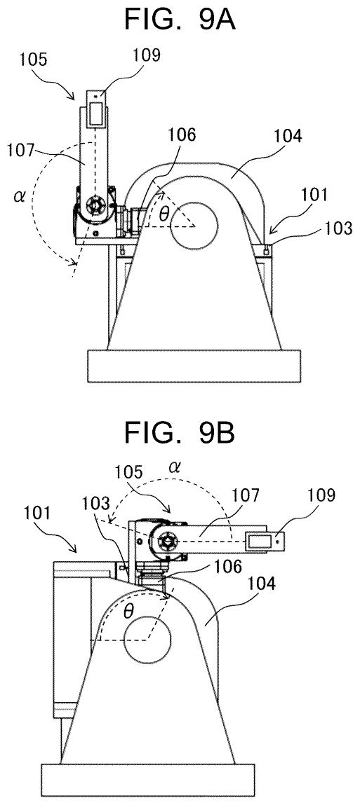

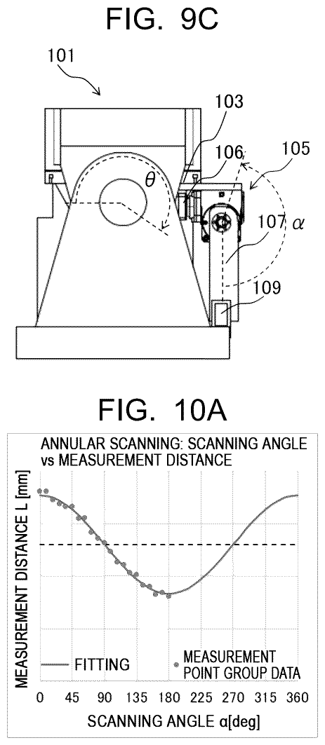

The rotary member 101 is fixed at the designated measurement position, the rotary mechanism 106 rotates the support member 107 at the measurement position of the rotary member 101, and the displacement meter 109 measures the distance to the inclined reference surface 110 at a plurality of scanning angles due to the rotation of the support member 107. FIG. 9A illustrates a case where the designated measurement position of the rotary member 101 is the rotational movement angle θ=0° and the displacement meter 109 is positioned at the scanning start point (α=0°) as the position to start rotation of the displacement meter 109. The rotary member 101 is fixed at the rotational movement angle θ=0° as the designated measurement position, the rotary mechanism 106 rotates the support member 107 at the rotational movement angle θ=0° as the designated measurement position of the rotary member 101, and the displacement meter 109 measures the distance to the inclined reference surface 110 at the scanning angle α that is any rotation angle due to the rotation of the support member 107 from the scanning start point (α=0°). FIG. 9B illustrates a case where the designated measurement position of the rotary member 101 is the rotational movement angle θ=90° and the displacement meter 109 is positioned at the scanning start point (α=0°) as the position to start rotation of the displacement meter 109. The rotary member 101 is fixed at the rotational movement angle θ=90° as the designated measurement position, the rotary mechanism 106 rotates the support member 107 at the rotational movement angle θ=90° as the designated measurement position of the rotary member 101, and the displacement meter 109 measures the distance to the inclined reference surface 110 at the scanning angle α that is any rotation angle due to the rotation of the support member 107 from the scanning start point (α=0°). FIG. 9C illustrates a case where the designated measurement position of the rotary member 101 is the rotational movement angle θ=180° and the displacement meter 109 is positioned at the scanning start point (α=0°) as the position to start rotation of the displacement meter 109. The rotary member 101 is fixed at the rotational movement angle θ=180° as the designated measurement position, the rotary mechanism 106 rotates the support member 107 at the rotational movement angle θ=180° as the designated measurement position of the rotary member 101, and the displacement meter 109 measures the distance to the inclined reference surface 110 at the scanning angle α that is any rotation angle due to the rotation of the support member 107 from the scanning start point (α=0°).

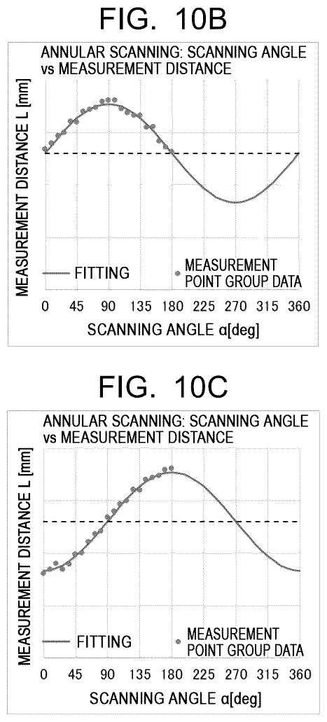

As illustrated in FIG. 10A, the distance waveform of the measurement distance L with respect to the scanning angle α when the rotational movement angle θ as the designated measurement position of the rotary member 101 is 0° is obtained by the displacement meter 109. In addition, as illustrated in FIG. 10B, the distance waveform of the measurement distance L with respect to the scanning angle α when the rotational movement angle θ as the designated measurement position of the rotary member 101 is 90° is obtained by the displacement meter 109. Further, as illustrated in FIG. 10C, the distance waveform of the measurement distance L with respect to the scanning angle α when the rotational movement angle θ as the designated measurement position of the rotary member 101 is 180° is obtained by the displacement meter 109. Since the phase of the distance waveform of the measurement distance L changes in accordance with the rotational movement angle θ as the measurement position of the rotary member 101, the displacement meter 109 measures the distance waveform of the measurement distance L from the displacement meter 109 to the inclined reference surface 110 at each scanning angle α at the rotational movement angle θ as each designated measurement position, and the rotational movement angle θ as each designated measurement position of the rotary member 101 can be obtained based on the phase difference between the distance waveforms of the measurement distance L at the rotational movement angles θ as the plurality of designated measurement positions. In other words, the rotational movement angle θ when the rotary member 101 is rotationally moved can be obtained by obtaining the phase difference θ between the two distance waveforms of the measurement distance L. In this manner, the rotational movement angle θ as a measurement position that is the state of the rotary member 101 can be measured based on the measurement distance L at the plurality of scanning angles α.

The rotational movement angle θ as the measurement position of the rotary member 101 may be obtained from the distance waveform of the measurement distance L based on point group data of measured values as illustrated in FIGS. 10A to 10C, but may be obtained from the distance waveform of the measurement distance L obtained by curve-fitting the point group data of measured values as illustrated in FIGS. 10A to 10C. Note that the distance waveform of the measurement distance L does not need to be obtained for the scanning angle α in the range of 0° to 360°, and the distance waveform of the measurement distance L in a non-measured range of the scanning angle α may be supplemented with that obtained by curve-fitting point group data of measured values as illustrated in FIGS. 10A to 10C.

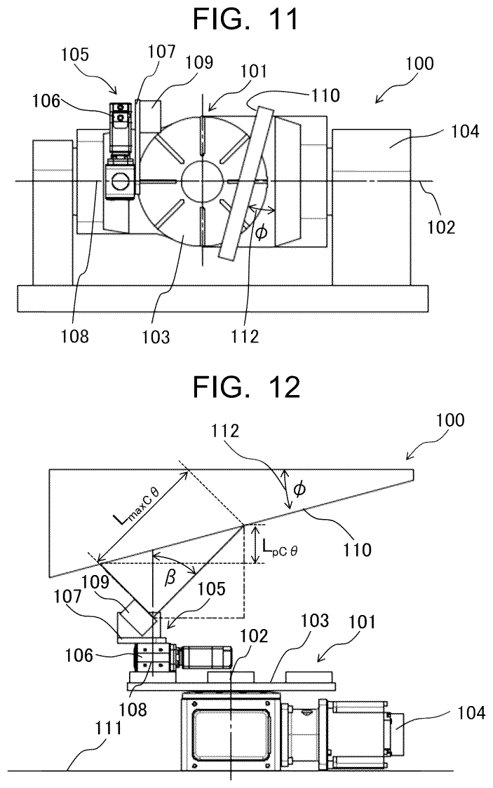

In the system 100 in FIGS. 7A to 9C, the measurement device 105 is disposed on the surface 103 of the rotary member 101, and the inclined reference surface 110 is inclined at the angle φ of the tilt angle 112 relative to the plane perpendicular to the rotary member axis line 102 and disposed to face the measurement device 105. However, as illustrated in FIG. 11, the inclined reference surface 110 may be inclined at the angle φ of the tilt angle 112 relative to the plane perpendicular to the rotary member axis line 102 and disposed on the surface 103 of the rotary member 101, and the measurement device 105 may be disposed in the plane perpendicular to the rotary member axis line 102 to face the inclined reference surface 110, and as long as the support member axis line 108 is parallel to the rotary member axis line 102 even when the disposition places of the measurement device 105 and the inclined reference surface 110 are changed, as in the system 100 in FIGS. 7A to 9C, the displacement meter 109 measures the distance waveform of the measurement distance L from the displacement meter 109 to the inclined reference surface 110 at each scanning angle α at the rotational movement angle θ as each designated measurement position, and the rotational movement angle θ as each designated measurement position of the rotary member 101 can be obtained based on the phase difference between the distance waveforms of the measurement distance L at the rotational movement angles θ as the plurality of designated measurement positions.

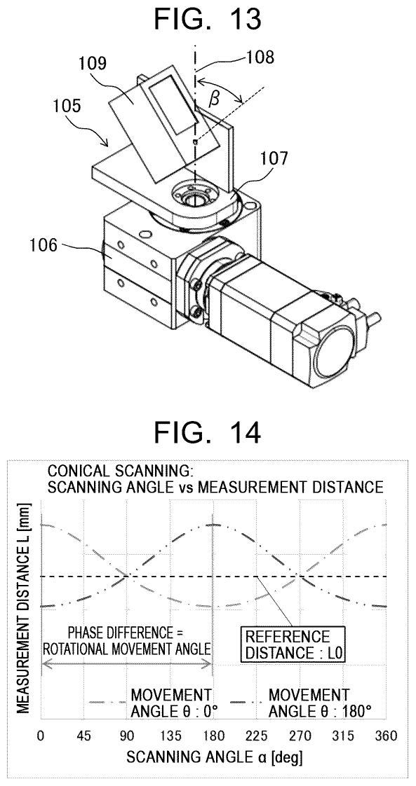

The system 100 for measuring the state of the rotary member 101 that can rotate around the rotary member axis line 102, as another embodiment according to the present invention will be described below with reference to FIGS. 12 to 14. In the system 100 in FIGS. 1 to 3B, the displacement meter 109 measures the distance to the inclined reference surface 110 in a direction parallel to the support member axis line 108, but in the system 100 in FIGS. 12 and 13, the displacement meter 109 measures the distance to the inclined reference surface 110 in a direction tilted at an angle β relative to the support member axis line 108. Moreover, in the system 100 in FIGS. 1 to 3B, the displacement meter 109 is disposed on the support member 107 away from the support member axis line 108 by the distance corresponding to the scanning radius r, but in the system 100 in FIGS. 12 and 13, the displacement meter 109 is disposed on the support member 107 such that a start point for measuring the distance to the inclined reference surface 110 substantially coincides with the support member axis line 108. For example, in a 30) case where the displacement meter 109 is a laser distance meter, the laser beam radiation part of the displacement meter 109 substantially coincides with the support member axis line 108. At other points, the configuration of the system 100 in FIGS. 12 and 13 is the same as the configuration of the system 100 in FIGS. 1 to 3B.

When the scanning angle α of the displacement meter 109 is 0° to 360°, a measurement distance L_{c} from the displacement meter 109 to the inclined reference surface 110 is obtained as the distance waveform of the following expression.

$${L}_{C} = {L}_{max C θ} \{ cos ( β ) - \frac{( 1 - cos ( α + θ ) ) sin ( β )}{\frac{1}{tan ( φ )} - tan ( β ) cos ( α + θ )} \} \qquad [ MATH . 5 ]$$

In the expression, L_{maxCθ} represents the maximum detectable distance from the displacement meter 109 to the inclined reference surface 110 when the rotational movement angle θ is at the designated measurement position of the rotary member 101. A bilateral amplitude L_{pC} of the measurement distance L_{c} from the displacement meter 109 to the inclined reference surface 110 is obtained by the following expression.

$${L}_{pC} = {L}_{maxC} \{ cos ( β ) - \frac{cos ( β ) - sin ( β ) tan ( φ )}{tan ( β ) tan ( φ ) + 1} \} \qquad [ MATH . 6 ]$$

As illustrated in FIG. 14, the distance waveform of a measurement distance L_{C} with respect to the scanning angle α when the rotational movement angle θ as the designated measurement position of the rotary member 101 is 0° and 180° is obtained from [MATH. 5]. Note that, in FIG. 14, the distance waveform is adjusted so that the reference distance L_{oθ} does not depend on the rotational movement angle θ but is equal. For example, in [MATH. 5], the distance waveform is adjusted so that the reference distance L_{oθ} when α+θ=90° does not depend on the rotational movement angle θ but is equal to Lₒ. Since the phase of the distance waveform of the measurement distance L_{C} changes in accordance with the rotational movement angle θ as the measurement position of the rotary member 101, the displacement meter 109 measures the distance waveform of the measurement distance L_{c} from the displacement meter 109 to the inclined reference surface 110 at each scanning angle α at the rotational movement angle θ as each designated measurement position, and the rotational movement angle θ as each designated measurement position of the rotary member 101 can be obtained based on the phase difference between the distance waveforms of the measurement distance L_{c} at the rotational movement angles θ as the plurality of designated measurement positions. In other words, the rotational movement angle θ when the rotary member 101 is rotationally moved can be obtained by obtaining the phase difference θ between the two distance waveforms of the measurement distance L_{C}. In this manner, the rotational movement angle θ as a measurement position that is the state of the rotary member 101 can be measured based on the measurement distance L_{C} at the plurality of scanning angles α.

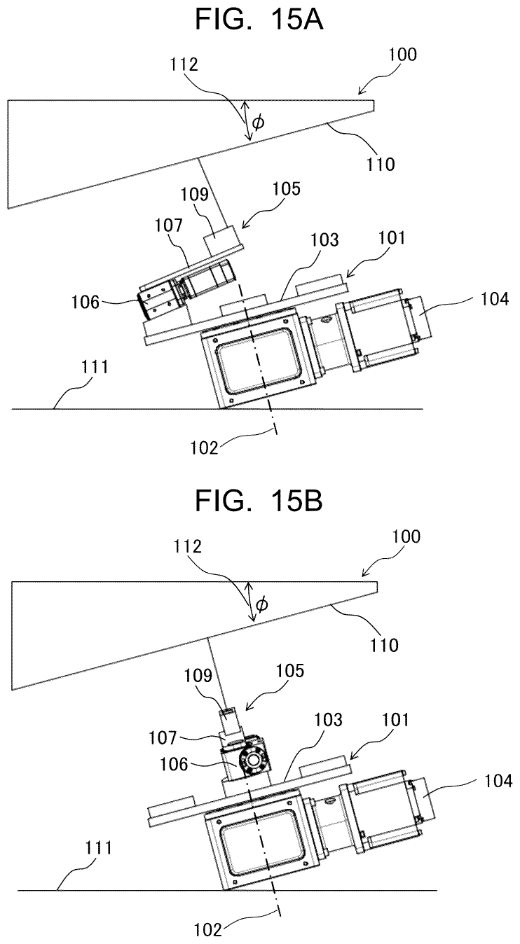

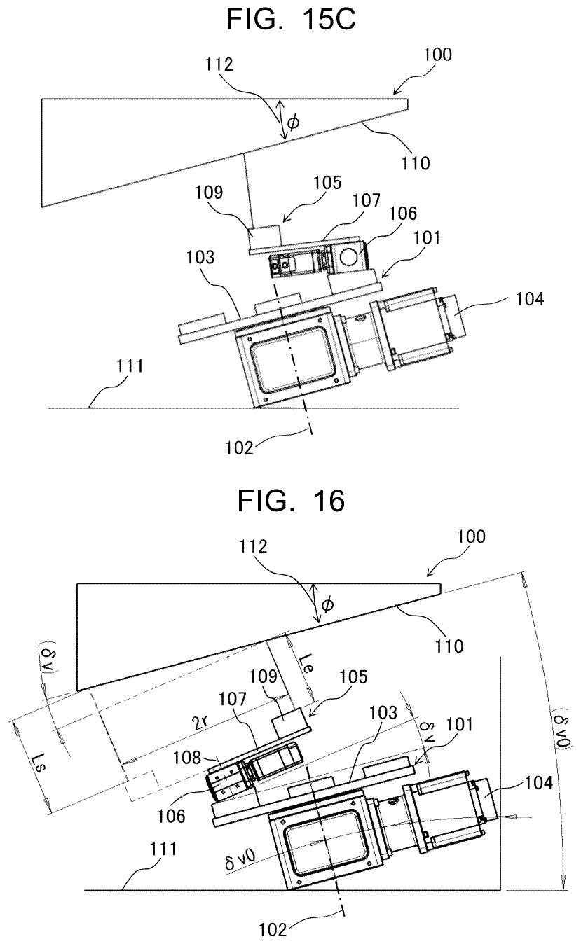

The system 100 for measuring the state of the rotary member 101 that can rotate around the rotary member axis line 102 will be described below with reference to FIGS. 15A to 16. The configuration of the system 100 in FIGS. 15A to 16 is the same as the configuration of the system 100 in FIGS. 1 to 3B. The displacement meter 109 of the measurement device 105 is fixed to the rotary member 101 with the scanning angle α, and the displacement meter 109 measures the distance to the inclined reference surface 110 while the rotary member 101 is rotated by 360°. For example, the displacement meter 109 measures the distance to the inclined reference surface 110 when the rotational movement angle θ of the rotary member 101 is ( ) as illustrated in FIG. 15A, the displacement meter 109 measures the distance to the inclined reference surface 110 when the rotational movement angle θ of the rotary member 101 is 90° as illustrated in FIG. 15B, and the displacement meter 109 measures the distance to the inclined reference surface 110 when the rotational movement angle θ of the rotary member 101 is 180° as illustrated in FIG. 15C. While the rotary member 101 is rotated by 360°, the tilt of the rotary member 101 and/or the inclined reference surface 110 is adjusted so that the distance to the inclined reference surface 110, which is measured by the displacement meter 109 is constant. For example, the tilt of the rotary device 104 that rotates the rotary member 101 may be adjusted relative to the inclined reference surface 110 while the inclined reference surface 110 is fixed, or the tilt of the inclined reference surface 110 may be adjusted relative to the rotary member 101 while the rotary device 104 is fixed to a reference surface 111. Accordingly, the inclined reference surface 110 is disposed perpendicular to the rotary member axis line 102 of the rotary member 101. Note that the rotary member 101 does not necessarily need to be rotated by 360° and may be rotated by less than 360°, for example, by 180°.

As illustrated in FIG. 16, when the rotary member 101 rotates such that the surface 103 of the rotary member 101 is substantially perpendicular to the rotary member axis line 102, the rotary mechanism 106 rotates the displacement meter 109 while the rotational movement angle θ of the rotary member 101 is fixed, and the displacement meter 109 measures the distance to the inclined reference surface 110 at two scanning angles α. For example, as illustrated in FIG. 16, the displacement meter 109 is fixed with the scanning angle α=αₛ and measures a distance Lₛ to the inclined reference surface 110. The displacement meter 109 is rotated, is fixed with the scanning angle α=α_{c}=αₛ+180°, and measures a distance Lₑ to the inclined reference surface 110. Perpendicularity δᵥ, per any reference length L_{ref}, of a part of the surface 103 of the rotary member 101 where the measurement device 105 is disposed, with respect to the rotary member axis line 102 is defined by a displacement amount of the following expression.

$${δ}_{ν} = \frac{{L}_{s} - {L}_{e}}{2 r} \times {L}_{ref} \qquad [ MATH . 7 ]$$

Note that “substantially perpendicular” means that the part of the surface 103 of the rotary member 101 where the measurement device 105 is disposed is inclined relative to the plane perpendicular to the rotary member axis line 102 with the perpendicularity δᵥ. The perpendicularity δᵥ of the part of the surface 103 of the rotary member 101 where the measurement device 105 is disposed, with respect to the rotary member axis line 102 can be obtained from [MATH. 7]. Further, perpendicularity δᵥ₀ of the rotary member axis line 102 with respect to the reference surface 111 is equivalent to the angle φ of the inclined reference surface 110 with respect to the reference surface 111. The perpendicularity δᵥ₀ can be obtained by, for example, a precision level or calculation based on the maximum and minimum heights of the inclined reference surface 110 from the reference surface 111. For the system 100 in FIG. 6B, as in the system 100 in FIGS. 15A to 16, the perpendicularity δᵥ of a part of the surface 103 of the rotary member 101 where the inclined reference surface 110 is disposed, with respect to the rotary member axis line 102 can be obtained.

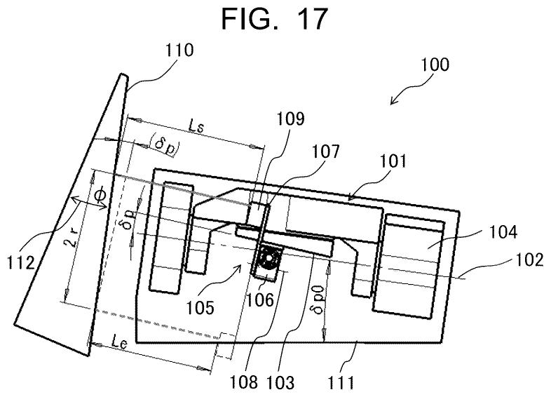

The system 100 for measuring the state of the rotary member 101 that can rotate around the rotary member axis line 102 will be described below with reference to FIG. 17. The configuration of the system 100 in FIG. 17 is the same as the configuration of the system 100 in FIGS. 7A to 9C. The displacement meter 109 of the measurement device 105 is fixed to the rotary member 101 with the scanning angle α, and the displacement meter 109 measures the distance to the inclined reference surface 110 while the rotary member 101 is rotated. While the rotary member 101 is rotated, the tilt of the rotary member 101 and/or the inclined reference surface 110 is adjusted so that the distance to the inclined reference surface 110, which is measured by the displacement meter 109 is constant. Accordingly, the inclined reference surface 110 is disposed perpendicular to the rotary member axis line 102 of the rotary member 101.

As illustrated in FIG. 17, when the rotary member 101 rotates such that the surface 103 of the rotary member 101 is substantially parallel to the rotary member axis line 102, as in the system in FIGS. 15A to 16, the rotary mechanism 106 rotates the displacement meter 109 while the rotational movement angle θ of the rotary member 101 is fixed, and the displacement meter 109 measures the distance to the inclined reference surface 110 at two scanning angles α. For example, as illustrated in FIG. 17, the displacement meter 109 is fixed with the scanning angle α=αₛ and measures the distance Lₛ to the inclined reference surface 110. The displacement meter 109 is rotated, is fixed with the scanning angle α=αₑ=αₛ+180°, and measures the distance Lₑ to the inclined reference surface 110. Parallelism δₚ, per any reference length L_{ref}, of the part of the surface 103 of the rotary member 101 where the measurement device 105 is disposed, with respect to the rotary member axis line 102 is defined by a displacement amount of the following expression.

$${δ}_{p} = \frac{{L}_{s} - {L}_{e}}{2 r} \times {L}_{ref} \qquad [ MATH . 8 ]$$

Note that “substantially parallel” means that the part of the surface 103 of the rotary member 101 where the measurement device 105 is disposed is inclined relative to a plane parallel to the rotary member axis line 102 with the parallelism δₚ. The parallelism δₚ of the part of the surface 103 of the rotary member 101 where the measurement device 105 is disposed, with respect to the rotary member axis line 102 can be obtained from [MATH. 8]. Further, parallelism δₚ₀ of the rotary member axis line 102 with respect to the reference surface 111 is equivalent to the angle φ of the inclined reference surface 110 and can be obtained by, for example, a right-angle square. For the system 100 in FIG. 11, as in the system 100 in FIG. 17, the parallelism δₚ of the part of the surface 103 of the rotary member 101 where the inclined reference surface 110 is disposed, with respect to the rotary member axis line 102 can be obtained.

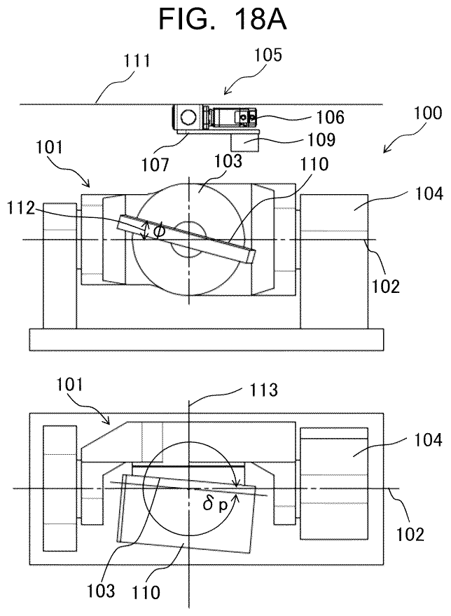

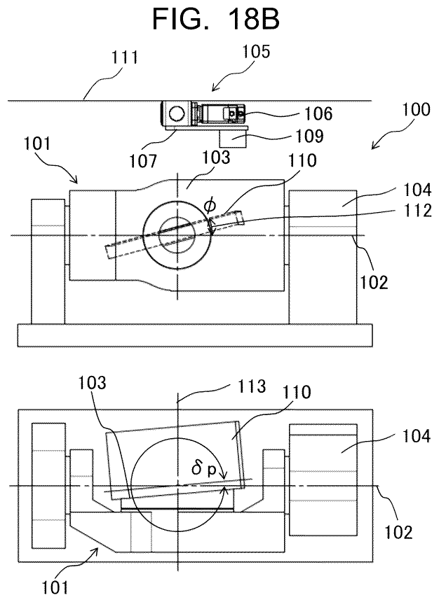

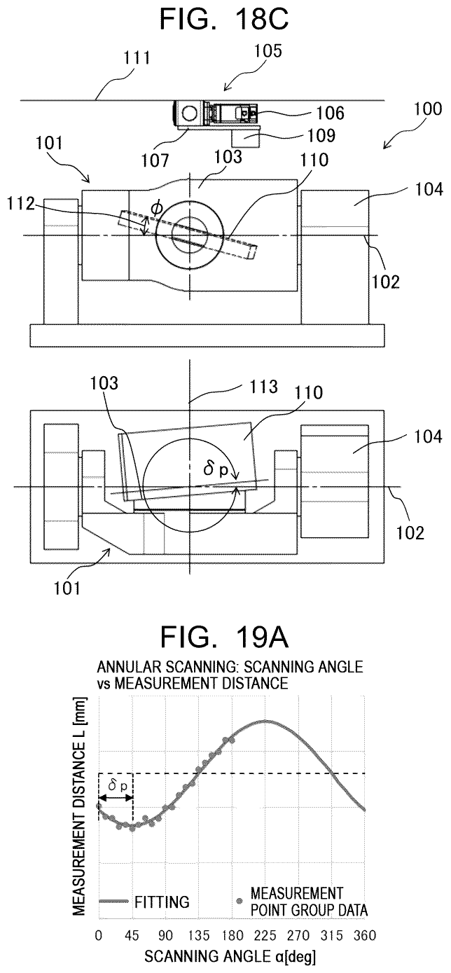

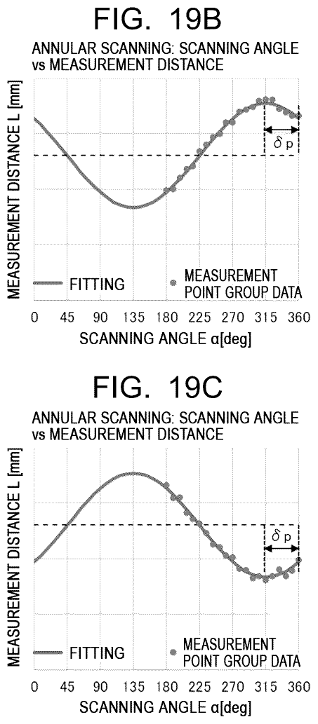

The system 100 for measuring the state of the rotary member 101 that can rotate around the rotary member axis line 102, as another embodiment according to the present invention will be described below with reference to FIGS. 18A to 19C. The inclined reference surface 110 is disposed orthogonal to the surface 103 of the rotary member 101 such that the tilt angle 112 is equal to the angle φ relative to the rotary member axis line 102. A central axis line 113 is set orthogonal to the rotary member axis line 102 and included in the inclined reference surface 110. The measurement device 105 is disposed such that the support member axis line 108 is orthogonal to both the rotary member axis line 102 and the central axis line 113 and the measurement device 105 faces the inclined reference surface 110. FIG. 18A illustrates a case where the designated measurement position of the rotary member 101 is the rotational movement angle θ=0° and the displacement meter 109 is positioned at the scanning start point (α=0°) as the position to start rotation of the displacement meter 109. The rotary member 101 is fixed at the rotational movement angle θ=0° as the designated measurement position, the rotary mechanism 106 rotates the support member 107 at the rotational movement angle θ=0° as the designated measurement position of the rotary member 101, and the displacement meter 109 measures the distance to the inclined reference surface 110 at the scanning angle α that is any rotation angle due to the rotation of the support member 107 from the scanning start point (α=0°). As illustrated in FIG. 19A, the distance waveform of the measurement distance L with respect to the scanning angle α when the rotational movement angle θ as the designated measurement position of the rotary member 101 is 0° is obtained by the displacement meter 109. Note that, in FIG. 19A, the measurement distance L is measured when the scanning angle α=0° to 180°.

FIG. 18B illustrates a case where the designated measurement position of the rotary member 101 is the rotational movement angle θ=180° and the displacement meter 109 is positioned at the scanning start point (α=0°) as the position to start rotation of the displacement meter 109. The rotary member 101 is fixed at the rotational movement angle θ=180° as the designated measurement position, the rotary mechanism 106 rotates the support member 107 at the rotational movement angle θ=180° as the designated measurement position of the rotary member 101, and the displacement meter 109 measures the distance to the inclined reference surface 110 at the scanning angle α that is any rotation angle due to the rotation of the support member 107 from the scanning start point (α=0°). As illustrated in FIG. 19B, the distance waveform of the measurement distance L with respect to the scanning angle α when the rotational movement angle θ as the designated measurement position of the rotary member 101 is 180° is obtained by the displacement meter 109. Note that, in FIG. 19B, the measurement distance L is measured when the scanning angle α=90° to 180°.

The phase difference of 180°+2δₚ is obtained by comparing the distance waveform of the measurement distance L obtained based on FIG. 19A and the distance waveform of the measurement distance L obtained based on FIG. 19B, and accordingly, the parallelism δₚ of the part of the surface 103 of the rotary member 101 where the inclined reference surface 110 is disposed, with respect to the rotary member axis line 102 can be obtained. Note that, since the distance waveform of the measurement distance L is obtained for one surface of the inclined reference surface 110 in FIG. 18A, whereas the distance waveform of the measurement distance L is obtained for the other surface of the inclined reference surface 110) in FIG. 18B, the parallelism of both surfaces of the inclined reference surface 110 is preferably high.

FIG. 18C illustrates a case where the designated measurement position of the rotary member 101 is the rotational movement angle θ=180°, the inclined reference surface 110 is disposed such that the angle φ of the tilt angle 112 is the same as in FIG. 18A, and the displacement meter 109 is positioned at the scanning start point (α=0°) as the position to start rotation of the displacement meter 109. The rotary member 101 is fixed at the rotational movement angle θ=180° as the designated measurement position, the rotary mechanism 106 rotates the support member 107 at the rotational movement angle θ=180° as the designated measurement position of the rotary member 101, and the displacement meter 109 measures the distance to the inclined reference surface 110 at the scanning angle α that is any rotation angle due to the rotation of the support member 107 from the scanning start point (α=( )). As illustrated in FIG. 19C, the distance waveform of the measurement distance L with respect to the scanning angle α when the rotational movement angle θ as the designated measurement position of the rotary member 101 is 180° is obtained by the displacement meter 109. Note that, in FIG. 19C, the measurement distance L is measured when the scanning angle α=90° to 180°.

The phase difference of 2δₚ is obtained by comparing the distance waveform of the measurement distance L obtained based on FIG. 19A and the distance waveform of the measurement distance L obtained based on FIG. 19C, and accordingly, the parallelism δₚ of the part of the surface 103 of the rotary member 101 where the inclined reference surface 110 is disposed, with respect to the rotary member axis line 102 can be obtained. Note that, in FIGS. 18A and 18C, the distance waveform of the measurement distance L can be obtained for the same surface of the inclined reference surface 110. Although the angle φ of the tilt angle 112 in FIG. 18A and the angle φ of the tilt angle 112 in FIG. 18C are different in reality, the difference between these angles φ only appears as the difference in the bilateral amplitude Lₚ between two distance waveforms of the measurement distance L, and the phase difference of 2δₚ between the two distance waveforms of the measurement distance L can be obtained by normalizing the bilateral amplitude Lₚ to, for example, one. The distance waveform of the measurement distance L does not need to be obtained for the scanning angle α in the range of 0° to 360°, and the distance waveform of the measurement distance L in a non-measured range of the scanning angle α may be supplemented with that obtained by curve-fitting point group data of measured values as illustrated in FIGS. 19A to 19C.

It should be further understood by persons skilled in the art that although the foregoing description has been made on embodiments of the present invention, the present invention is not limited thereto and various changes and modifications may be made without departing from the principle of the present invention and the scope of the appended claims.

### REFERENCE SIGNS LIST

100 system
101 rotary member
102 rotary member axis line
103 rotary member surface
104 rotary device
105 measurement device
106 rotary mechanism
107 support member
108 support member axis line
109 displacement meter
110 inclined reference surface
111 reference surface
112 tilt angle
113 central axis line

1. A system for measuring a state of a rotary member that can rotate around a rotary member axis line, the system comprising a measurement device including: a rotary mechanism; a support member that can rotate around a support member axis line by means of the rotary mechanism; and a displacement meter that is disposed on the support member, wherein
the system further includes an inclined reference surface and the displacement meter is configured to measure a distance to the inclined reference surface,
the rotary member is fixed at a designated measurement position, the rotary mechanism rotates the support member at the measurement position of the rotary member, and the displacement meter measures the distance to the inclined reference surface at a plurality of scanning angles due to the rotation of the support member and measures the state of the rotary member based on the distance at the plurality of scanning angles.

2. The system according to claim 1, wherein the rotary member is fixed at a plurality of designated measurement positions, the rotary mechanism rotates the support member at each designated measurement position of the rotary member, and the displacement meter measures the distance to the inclined reference surface at a plurality of scanning angles due to the rotation of the support member.

3. The system according to claim 2, wherein the displacement meter measures a distance waveform of the distance to the inclined reference surface with respect to each scanning angle at each designated measurement position and measures a rotational movement angle at each designated measurement position of the rotary member based on a phase difference between the distance waveforms at the plurality of designated measurement positions.

4. The system according to claim 2, wherein the rotary mechanism starts rotation of the displacement meter through the support member from the same position relative to the rotary member at each designated measurement position.

5. The system according to claim 1, wherein the support member axis line is parallel to the rotary member axis line.

6. The system according to claim 1, wherein the displacement meter measures the distance to the inclined reference surface in a direction parallel to the support member axis line.

7. The system according to claim 1, wherein the displacement meter measures the distance to the inclined reference surface in a direction tilted relative to the support member axis line.

8. The system according to claim 1, wherein the measurement device is disposed on a surface of the rotary member and the inclined reference surface is inclined at a specific angle relative to a plane perpendicular to the rotary member axis line and disposed to face the measurement device, or the inclined reference surface is inclined at a specific angle relative to a plane perpendicular to the rotary member axis line and disposed on the surface of the rotary member and the measurement device is disposed in the plane perpendicular to the rotary member axis line to face the inclined reference surface.

9. The system according to claim 8, wherein in a case where the rotary member rotates so that the surface of the rotary member is substantially perpendicular to the rotary member axis line, perpendicularity of a part of the surface of the rotary member where the measurement device or the inclined reference surface is disposed, relative to the rotary member axis line is measured based on the distance to the inclined reference surface.

10. The system according to claim 8, wherein in a case where the rotary member rotates so that the surface of the rotary member is substantially parallel to the rotary member axis line, parallelism of a part of the surface of the rotary member where the measurement device or the inclined reference surface is disposed, relative to the rotary member axis line is measured based on the distance to the inclined reference surface.
